(19) United States
(12) Patent Application Publication
(10) Pub. No.: US 2004/0058719 A1
(43) Pub. Date: Mar. 25, 2004

(54) Communication device holder

(75) Inventor: Todd Condiff, Sachse, TX (US)

Correspondence Address: Timothy L. Scott, Suite 1100, 10333 Richmond, Houston, TX, 77042, US

(73) Assignee: Harness Tek, Inc.

(21) Appl. No.: 10/671,274

(22) Filed: Sep. 25, 2003

Related U.S. Application Data
(62) Division of application No. 09/978,939, filed on Oct. 18, 2001, now abandoned.

(51) Int. Cl. H04M 1/00

(52) U.S. Cl. 455/575.1; 455/575.6

(57) ABSTRACT

A first and second device holder (110,210) having an envelope (12) having a complimentary configuration to a device. A first strap (116) is securely fastened at a bottom distal end to a top end of the envelope (12). A clip securely connected at a bottom end to a top distal end of the first strap (116). A third device holder (310) has a second strap (216). A circumferential expandable upper holder (20U) is securely attached to top end of the second strap (216) and a circumferential expandable lower holder (20L) securely attached to bottom end of the second strap (216). A clip securely connected at a bottom end to a top distal end of the first strap (116).

### BACKGROUND OF THE INVENTION

1. Field of the Invention

The present invention relates to a cellular phone holder. More particularly, the present invention relates to a cellular phone holder having a novel attachment means.

2. Description of the Prior Art

Numerous innovations for cell phone holders have been provided in the prior art that are described as follows. Even though these innovations may be suitable for the specific individual purposes to which they address, they differ from the present invention as hereinafter contrasted.

In U.S. Pat. No. 5,850,954, by inventor, Dong-Joo, Titled, Holder assembly for cellular phones, a holder assembly for cellular phones is disclosed. The holder assembly allows a cellular phone to be smoothly rotated around a holding button in either direction when a user, having the phone on his belt, is seated and presses against the top end of the phone. Therefore, the holder assembly allows the phone to be almost free from pressing against a user's body when the user is seated. The holder assembly overloads or tensions neither the clip of the holder nor a user's belt, thereby allowing the clip to be free from being deformed and the user's belt to be free from being unexpectedly torn. The holding button may be attached to a cellular phone or a phone case.

In U.S. Pat. No. 3,990,617, by inventor, Carter, Titled, Belt radio clip, a clip-on carrying device for portable personal radios, particularly a radio of the two-way type conventionally used by police officers, firemen and the like. The carrying device includes a first radio receiving portion to which is attached an elongated belt receiving member having a hook-like portion formed thereon to prevent accidental removal of the clip from the belt. The radio receiving portion frictionally engages the outer case of the radio to securely hold the radio therein yet allowing easy removal of the radio when desired.

In U.S. Pat. No. 3,956,701, by inventor, James, Jr., et al., Titled, Personal paging receiver with swivel clip and distributed antenna, a personal paging device is housed in a case which has one dimension (length) longer than its width or thickness, and a clip is affixed to a side on a swivel between the ends of the length dimension, which allows the device to be worn on the person in a vertical or a horizontal posture. A radio receiving antenna is carried on a flexible dielectric sheet within the casing, and radio components are enclosed within that sheet. A pair of orthogonally-related antenna loops can be provided on the dielectric sheet. The swivel clip can be arranged to cooperate with these or other antennas in a circular-polarization antenna system, such that in one orientation one or the other of the antennas will be detuned.

The patented inventions differ from the present invention because the patented inventions lack one or more of the following features: cellular phone holder with strap having an optional clip and belt clip attached to a distal end of the strap.

Numerous innovations for cell phone holders have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention relates to a cellular phone holder. More particularly, the present invention relates to a cellular phone holder having a novel attachment means.

The types of problems encountered in the prior art are cell phone holders clip onto the belt utilizing rigid means but are not versatile.

In the prior art, unsuccessful attempts to solve this problem were attempted namely: belt clips on case or removable belt clips attached to cell phone. However, the problem was solved by the present invention because utilizes a novel attachment means.

Innovations within the prior art are rapidly being exploited in the field of cellular phone accessories.

The present invention went contrary to the teaching of the art which describes and claims belt clips and holders.

The present invention solved a long felt need for a secure versatile cell phone holder.

Accordingly, it is an object of the present invention to provide an envelope, fastener, strap, and clip.

More particularly, it is an object of the present invention to provide the fastener having a female fastener and a male fastener.

In keeping with these objects, and with others which will become apparent hereinafter, one feature of the present invention resides, briefly stated, in the strap being a first strap or a second strap.

When the clip is designed in accordance with the present invention, it has a first clip or a second clip.

In accordance with another feature of the present invention, the first clip has a first clip loop and a first clip lever.

Another feature of the present invention is that the second clip has a second clip loop, second clip lever, second clip ring, and second clip shaft.

Yet another feature of the present invention is that the device may optionally have an upper holder and lower holder.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### LIST OF REFERENCE NUMERALS UTILIZED IN THE DRAWINGS

110—first device holder (110)

210—second device holder (210)

310—third device holder (310)

12—envelope (12)

14—fastener (14)

14A—female fastener (14A)

14B—male fastener (14B)

116—first strap (116)

216—second strap (216)

118—first clip (118)

118A—first clip loop (118A)

118B—first clip lever (118B)

218—second clip (218)

218A—second clip loop (218A)

218B—second clip lever (218B)

218C—second clip ring (218C)

218D—second clip shaft (218D)

20U—upper holder (20U)

20L—lower holder (20L)

### BRIEF DESCRIPTION OF THE DRAWINGS

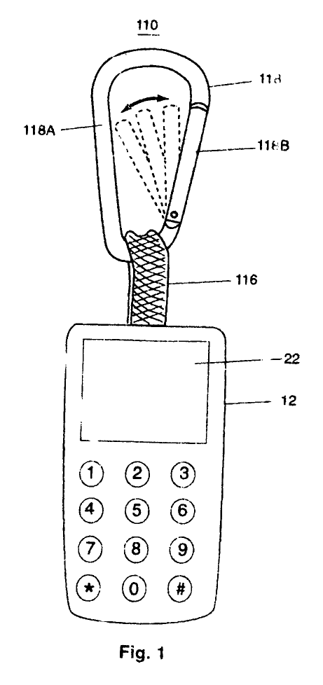

FIG. 1 is a front view of a first device holder (110).

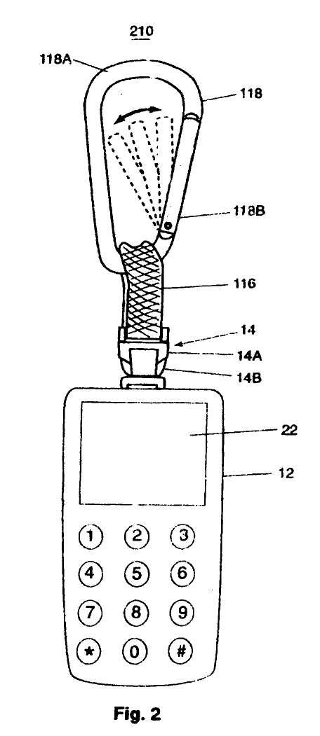

FIG. 2 is a front view of a second device holder (210).

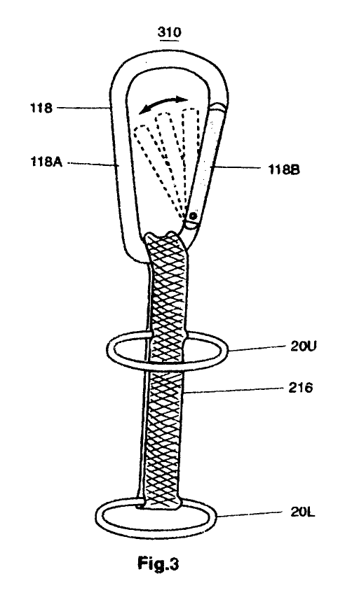

FIG. 3 is a front view of a third device holder (310).

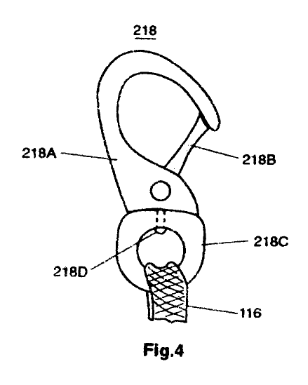

FIG. 4 is a side view of a second clip (218).

### DESCRIPTION OF THE PREFERRED EMBODIMENT

Now referring to FIG. 1 and FIG. 2 which are a front view of a first device holder (110) and second device holder (210), respectively. The device holders (110, 210) comprise an envelope (12) having a complimentary configuration to a device.

The device holders (110, 210) further comprise a first strap (116) securely fastened at a bottom distal end to a top end of the envelope (12). In the second device holder (210), the first strap (116) comprises a fastener (14) spliced therein. The fastener (14) comprises a female fastener (14A) securely affixed at a top end to the bottom distal end of the first strap (116) and a complimentary configured male fastener (14B) securely affixed at a bottom end to a top end of the envelope (12).

The device holders (110, 210) further comprise a clip securely connected at a bottom end to a top distal end of the first strap (116). The clip is preferably a first clip (118) which comprises a first clip loop (118A) and a first clip lever (118B) pivotally mounted on the first clip loop (118A) forming a closure therebetween. The first clip lever (118B) comprises a biasing means to automatically make the closure with the first clip loop (118A).

Referring to FIG. 4 which is a side view of a second clip (218). The clip may optionally be a second clip (218) which comprises a second clip loop (218A) and a second clip lever (218B) pivotally mounted on the second clip loop (218A) forming a closure therebetween. A second clip ring (218C) is rotatably connected to the second clip loop (218A) by a second clip shaft (218D).

The device holders (110, 210) are not restricted to holding cellular phone and can be utilized for devices selected from a group consisting of cordless phone, cellular phone, personal data assistant, calculator, pocket personal computer, cassette player, CD ROM player, radio, DVD player, bar code scanner, E.P.I.R.B., light flasher and flashlight.

Now referring to FIG. 3 which is a front view of a third device holder (310) which comprises a second strap (216). The third device holder (310) further comprises a circumferential expandable upper holder (20U) securely attached to top end of the second strap (216) and a circumferential expandable lower holder (20L) securely attached to bottom end of the second strap (216). The second strap (216) may optionally comprise a fastener (14) spliced therein. The fastener (14) preferably comprises a female fastener (14A) and a complimentary configured male fastener (14B).

The third device holder (310) further comprises a clip securely connected at a bottom end to a top distal end of the first strap (116). The clip is preferably a first clip (118) which comprises a first clip loop (118A) and a first clip lever (118B) pivotally mounted on the first clip loop (118A) forming a closure therebetween. The first clip lever (118B) comprises a biasing means to automatically make the closure with the first clip loop (118A). The clip may optionally be a second clip (218) which comprises a second clip loop (218A) and a second clip lever (218B) pivotally mounted on the second clip loop (218A) forming a closure therebetween. A second clip ring (218C) is rotatably connected to the second clip loop (218A) by a second clip shaft (218D). Optionally, an outer edge of the lower holder (20L) is secondly securely connected to the second strap (216) between the upper holder (20U) and the first secure connection of the lower holder (20L) forming a cradle upon which the device rests upon a lower end of the second strap (216).

The third device holder (310) is not restricted to be only utilized for cellular phones but can be utilized for other devices selected from a group consisting of cordless phone, cellular phone, personal data assistant, calculator, pocket personal computer, cassette player, CD ROM player, radio, DVD player, bar code scanner, E.P.I.R.B., light flasher, and flashlight.

It will be understood that each of the elements described above, or two or more together, may also find a useful application in other types of constructions differing from the type described above.

While the invention has been illustrated and described as embodied in a cell phone holder, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

What is claimed is:

1. A first device holder (110) comprising:
A) an envelope (12) having a complimentary configuration to a device;
B) a first strap (116) securely fastened at a bottom distal end to a top end of the envelope (12); and
C) a clip securely connected at a bottom end to a top distal end of the first strap (116).

2. The first device holder (110) as described in claim 1, wherein the first strap (116) comprises a fastener (14) spliced therein.

3. The first device holder (110) as described in claim 2, wherein the fastener (14) comprises a female fastener (14A) securely affixed at a top end to the bottom distal end of the first strap (116) and a complimentary configured male fastener (14B) securely affixed at a bottom end to a top end of the envelope (12).

4. The first device holder (110) as described in claim 1, wherein the clip is a first clip (118) which comprises a first clip loop (118A) and a first clip lever (118B) pivotally mounted on the first clip loop (118A) forming a closure therebetween.

5. The first device holder (110) as described in claim 1, wherein the first clip lever (118B) comprises a biasing means to automatically make the closure with the first clip loop (118A).

6. The first device holder (110) as described in claim 1, wherein the clip is a second clip (218) which comprises a second clip loop (218A) and a second clip lever (218B) pivotally mounted on the second clip loop (218A) forming a closure therebetween, a second clip ring (218C) is rotatably connected to the second clip loop (218A) by a second clip shaft (218D).

7. The first device holder (110) as described in claim 1, wherein the device is selected from a group consisting of cordless phone, cellular phone, personal data assistant, calculator, pocket personal computer, cassette player, CD ROM player, radio, DVD player, bar code scanner, E.P.I.R.B., light flasher and flashlight.

8. A third device holder (310) comprising:
A) a second strap (216);
B) a circumferential expandable upper holder (20U) securely attached to top end of the second strap (216) and a circumferential expandable lower holder (20L) securely attached to bottom end of the second strap (216); and
C) a clip securely connected at a bottom end to a top distal end of the first strap (116).

9. The third device holder (310) as described in claim 8, wherein the second strap (216) comprises a fastener (14) spliced therein.

10. The third device holder (310) as described in claim 9, wherein the fastener (14) comprises a female fastener (14A) and a complimentary configured male fastener (14B).

11. The third device holder (310) as described in claim 8, wherein the clip is a first clip (118) which comprises a first clip loop (118A) and a first clip lever (118B) pivotally mounted on the first clip loop (118A) forming a closure therebetween.

12. The third device holder (310) as described in claim 8, wherein the first clip lever (118B) comprises a biasing means to automatically make the closure with the first clip loop (118A).

13. The third device holder (310) as described in claim 8, wherein the clip is a second clip (218) which comprises a second clip loop (218A) and a second clip lever (218B) pivotally mounted on the second clip loop (218A) forming a closure therebetween, a second clip ring (218C) is rotatably connected to the second clip loop (218A) by a second clip shaft (218D).

14. The third device holder (310) as described in claim 8, wherein the device is selected from a group consisting of cordless phone, cellular phone, personal data assistant, calculator, pocket personal computer, cassette player, CD ROM player, radio, DVD player, bar code scanner, E.P.I.R.B., light flasher, and flashlight.

15. The third device holder (310) as described in claim 8, wherein an outer edge of the lower holder (20L) is secondly securely connected to the second strap (216) between the upper holder (20U) and the first secure connection of the lower holder (20L) forming a cradle upon which the device rests upon a lower end of the second strap (216).
